(19) United States
(12) Patent Application Publication
(10) Pub. No.: US 2010/0220241 A1
(43) Pub. Date: Sep. 2, 2010

(54) Broadcast Receiving System and Control Method Therefor

(76) Inventor: Tomotaka Ida, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/627,757

(22) Filed: Nov. 30, 2009

(30) Foreign Application Priority Data
Feb. 27, 2009 (JP) 2009-046972

(51) Int. Cl. H04N 5/44; G04C 11/02

(52) U.S. Cl. 348/725; 368/47; 348/E05.096

(57) ABSTRACT

A broadcast receiving system according to an embodiment of the invention, is equipped with a module for displaying an on-timer setting menu, and a control module for referring to an internal clock which is corrected with reference clock information obtained from the outside and performing power control in accordance with the contents, input from a user via an operation module, on the on-timer setting menu. The control module allows selection of either of utilization and non-utilization of the clock information in the on-timer setting menu. The control module corrects the internal clock using the clock information and allows the power-on time to be set if the clock information is received from the outside and the utilization of the clock information has been selected and to allow the time until power on to be set without correcting the internal clock if the non-utilization of the clock information has been selected.

### CROSS-REFERENCE TO RELATED APPLICATIONS

This application is based upon and claims the benefit of priority from Japanese Patent Application No. 2009-046972, filed Feb. 27, 2009, the entire contents of which are incorporated herein by reference.

### BACKGROUND

1. Field

One embodiment of the present invention relates to a broadcast receiving system which has an on-timer function and a control method therefor.

2. Description of the Related Art

In recent years, broadcast receiving systems, such as television receivers, have increased their functions. One of the functions is the on-timer function (see, for example, Jpn. Pat. Appln. KOKAI Publication No. 2006-94358). This on-timer function is used to allow the receive operation of the broadcast receiving system to start by automatically turning on the power at the date and time specified by a user.

Conventional television receivers for analog broadcasting generally adopt a method to set in its internal clock circuit the time to the date and time at which the power is to be turned on and then detect the passage of the set time. In contrast, television receivers for digital broadcasting adopt a method to set the date and time to turn on the power and then detect the coincidence of the set time with the current time obtained by built-in clock circuit that is corrected on the basis of clock information contained in a received broadcast signal (hereinafter referred to as the broadcast clock information).

At present, the progress of change from analog broadcasting to digital broadcasting varies according to regions (mainly countries). In regions where digital broadcasting has started, clock information is embedded in a broadcast signal. However, there also exist some regions where the broadcast clock information is transmitted displaced in time from broadcasting stations. Television receivers for digital broadcasting are put on the market even in regions where the start of digital broadcasting is delayed, that is, digital broadcasting will be started in a short time. If the accurate broadcast clock information cannot be obtained from the above reasons, the normal operation cannot be expected even if the date and time to turn on the power has been set. Therefore, the on-timer function cannot be put to practical use.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic block diagram of a broadcast receiving system according to an embodiment of the present invention;

FIG. 2 shows the timer LED built in the broadcast receiving system shown in FIG. 1;

FIG. 3 shows various operating keys placed on the remote controller shown in FIG. 1;

FIG. 4 is a flowchart illustrating the command processing carried out by the microprocessor shown in FIG. 1;

FIG. 5 is a detailed flowchart illustrating the on-timer setting processing shown in FIG. 4;

FIG. 6 is a detailed flowchart illustrating the on-timer status display processing shown in FIG. 4;

FIG. 7 is a flowchart illustrating the power-on processing that the microprocessor shown in FIG. 1 carry out as a standby power operation;

FIG. 8 shows an example of setting the power-on time on the on-timer setting screen displayed by the processing shown in FIG. 5 when the broadcast or network clock information is utilized;

FIG. 9 shows an example of setting an input signal source at the power-on time on the on-timer setting screen (menu) displayed by the processing of FIG. 5 when neither broadcast nor network clock information is utilized;

FIG. 10 shows an example of setting off clock information although it can be obtained in the processing shown in FIG. 5;

FIG. 11 shows an example of setting the time required until the power is turned on as the result of settings shown in FIG. 10;

FIG. 12 shows an example of an on-timer status OSD display shown as the result of the processing of FIG. 6;

FIG. 13 is a flowchart illustrating a first modification of the on-timer setting processing shown in FIG. 5;

FIG. 14 shows an example of an on-timer setting menu displayed in the first modification of FIG. 13;

FIG. 15 is a flowchart illustrating a second modification of the on-timer setting processing shown in FIG. 5; and

FIG. 16 shows an example of an on-timer setting menu displayed in the second modification of FIG. 15.

### DETAILED DESCRIPTION

Various embodiments according to the invention will be described hereinafter. In general, according to one embodiment of the invention, there is provided a broadcast receiving system comprising: a receiving module configured to receive a broadcast signal; a display processing module configured to display an on-timer setting menu associated with at least the power-on of the receiving module; an operation module configured to perform input operations for setting items of the on-timer setting menu; and a control module configured to refer to an internal clock which is corrected with reference to clock information obtained from the outside and perform power control in accordance with the contents set by the input operations of the operation module on the on-timer setting menu. The control module is configured to allow user to select either of utilization and non-utilization of the clock information in the on-timer setting menu, to correct the internal clock using the clock information and allow the power-on time to be set in a detailed setting mode if the clock information is received from the outside and the utilization of the clock information has been selected, and to allow the time until power on to be set in a simple setting mode without correcting the internal clock if the non-utilization of the clock information has been selected.

In regions where the clock information is low in reliability, in order to avoid correction of the internal clock by the wrong clock information, the user is allowed to operate the operation module to set the time until power on in the on-timer setting menu. Accordingly, the on-timer function can be put to practical use.

The broadcast receiving system according to one embodiment of the invention will be described hereinafter with reference to the accompanying drawings. This broadcast receiving system is a television receiver that is capable of receiving signals for terrestrial analog broadcasting, DBS, and terrestrial digital broadcasting.

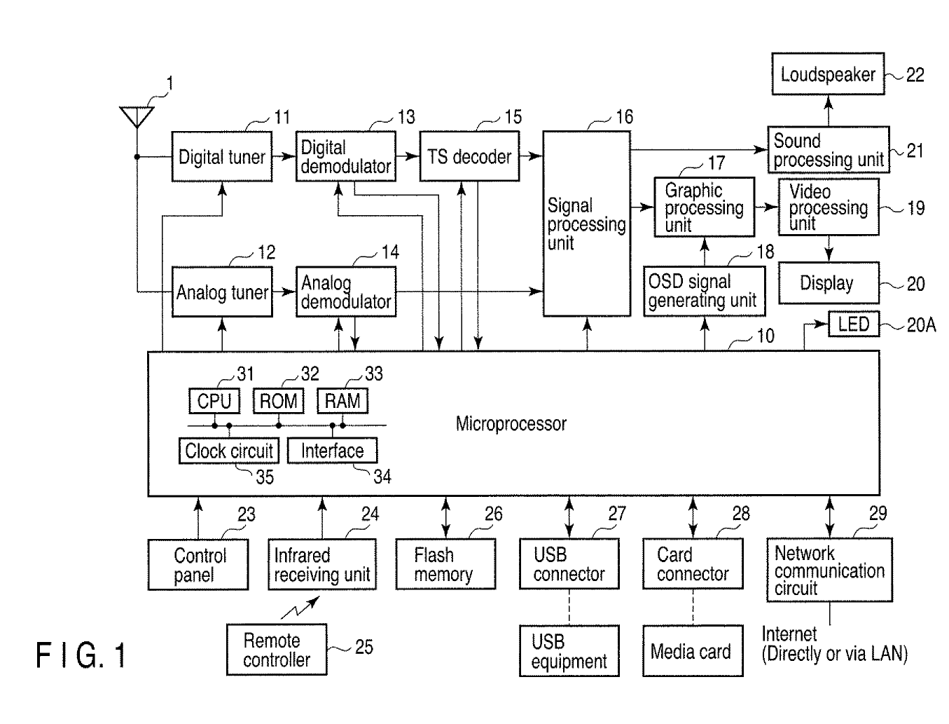

FIG. 1 schematically shows the arrangement of the broadcast receiving system. The broadcast receiving system is equipped with a microprocessor 10, a digital broadcast tuner 11, an analog broadcast tuner 12, a digital broadcast demodulator 13, an analog broadcast demodulator 14, and a TS decoder 15.

DBS and terrestrial digital broadcast signals are received by an antenna 1 and then applied to the digital tuner 11 as received signals. Terrestrial analog broadcast signals are received by the antenna 1 and then applied to the analog tuner 12 as received signals. The digital tuner 11 and the analog tuner 12, each of which is of the phase-locked loop (PLL) type, are each used to select a desired broadcast signal with receiving parameters, such as the central frequency, bandwidth, and the like specified under control of the microprocessor 10.

In the case of Japan by way of example, a broadcast signal selected by the digital tuner 11 is applied in sequence to the digital demodulator 13 of orthogonal frequency division multiplexing (OFDM) type and the TS decoder 15 where a digital video signal and a digital sound signal are demodulated and decoded. A received signal selected by the analog tuner 12 is applied to the analog demodulator 14 where an analog video signal and an analog sound signal are demodulated.

The broadcast receiving system further includes a signal processing unit 16, a graphic processing unit 17, an on-screen display (OSO) signal generating unit 18, a display unit 20, an on-timer light-emitting diode (LED) 20A, a sound processing unit 21, a loudspeaker 22, an operator panel 23, an infrared receiving unit 24, a remote controller 25, a flash memory 26, a Universal Serial Bus (USB) connector 27, a card connector 28, and a network communication circuit 29. The signal processing unit 16 performs predetermined digital signal processing on each of the digital video and sound signals from the TS decoder 15 and then applies the digital video and sound signals to the graphic processing unit 17 and the sound processing unit 21, respectively. In addition, the signal processing unit 16 digitizes each of the analog video and sound signals from the analog demodulator 14, then performs predetermined digital signal processing on each of the digitized video and sound signals and applies the digitized video and sound signals to the graphic processing unit 17 and the sound processing unit 21, respectively.

The graphic processing unit 17 superimposes an OSD signal generated by the OSD signal generating unit 18 on the digital video signal output from the signal processing unit and outputs the resultant digital video signal. The video processing unit 19 performs processing, such as size adjustment and digital to analog conversion on the digital video signal output from the graphic processing unit 18 in order to adapt it to the display unit 20. The display unit 20 displays a video corresponding to the video signal output from the video processing unit 19. The sound processing unit 21 performs processing, such as volume adjustment digital to analog conversion on the digital sound signal output from the signal processing unit 16 to adapt it to the loudspeaker 22. The loudspeaker 22 produces sound corresponding to the sound signal output from the sound processing unit 21.

The microprocessor 10 receives operation information from the operator panel 23 or operation information sent from the remote controller 25 and received by the infrared receiving unit 24 to control each component so that the operations corresponding to the operation information are carried out. The microprocessor 10 includes a central processing unit (CPU) 31 to perform various processes and control operations, a read-only memory (ROM) 33 to hold CPU control programs and a variety of initial data, a random access memory (RAM) 33 to provide a working area which temporarily stores CPU input/output information, an interface 34 to input or output setting information and control information for each component via an I²C bus or the like, and a clock circuit 35 which is corrected in accordance with clock information or date information obtained from a broadcast signal or via a network. The clock information obtained from the broadcast signal (broadcast clock information) is applied to the microprocessor 10 through the antenna 1, the digital tuner 11, the digital demodulator 13, and the TS decoder 15. On the other hand, the clock information obtained via the network (network clock information) is supplied to the microprocessor 10 through the network communication circuit 29.

The flash memory 26 is provided as a nonvolatile memory to store various items of setting information. The various items of setting information include default information associated with on-timer setting. The USB connector 27 is used to connect various items of USB equipment. The card connector 28 is set up to connect various media in the form of cards. The network communication circuit 29 is connected to the Internet directly or through a local area network (LAN).

The microprocessor 10 controls the OSD signal generating unit 18 to generate a variety of menus to be displayed on the display unit 20.

Here, the digital tuner 11, the analog tuner 12, the digital demodulator 13, the analog demodulator 14 and the TS decoder 15 make up a receiving module to receive broadcast signals. The operator panel 23 and the remote controller 25 forms an operation module which functions as a user interface to input setting entries of an on-timer setting menu. The signal processing unit 16, the graphic processing unit 17, the OSD signal generating unit 18 and the video processing unit 19 constitute a display processing module to display on the display 20 the on-timer setting menu which contains at least the time to turn on the power to the receiving module. The microprocessor 10 forms a control module which refers to the clock circuit 35 which is an internal clock that uses clock information from the outside as a correction reference to performs power control corresponding to the setting contents input from the operation module. The microprocessor 10 also prompts the user to choose either utilization (on) or non-utilization (off) of the clock information in the on-timer setting menu. If clock information can be obtained from the outside, and utilization of the clock information has been chosen, then the microprocessor corrects the internal clock in accordance with the clock information and allows the user to set the power-on time as a detailed setting mode. On the other hand, if non-utilization of the clock information has been selected, then the microprocessor 10 allows the user to set the time required until the power is turned on (hereinafter referred to as the time until power on) as a simple setting mode without correcting the internal clock.

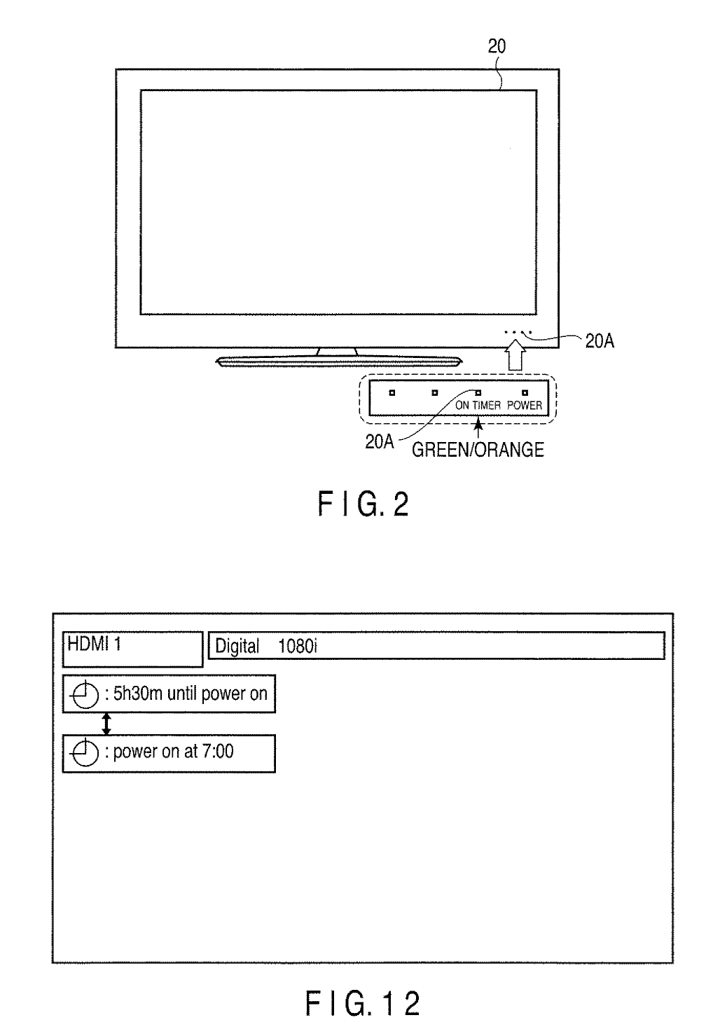

FIG. 2 shows the timer LED built in the broadcast receiving system. As shown in this diagram, the on-timer LED 20A is set in the lower portion of the front of the display unit 20. The on-timer LED 20A is lit in green or orange under control of the microprocessor 10.

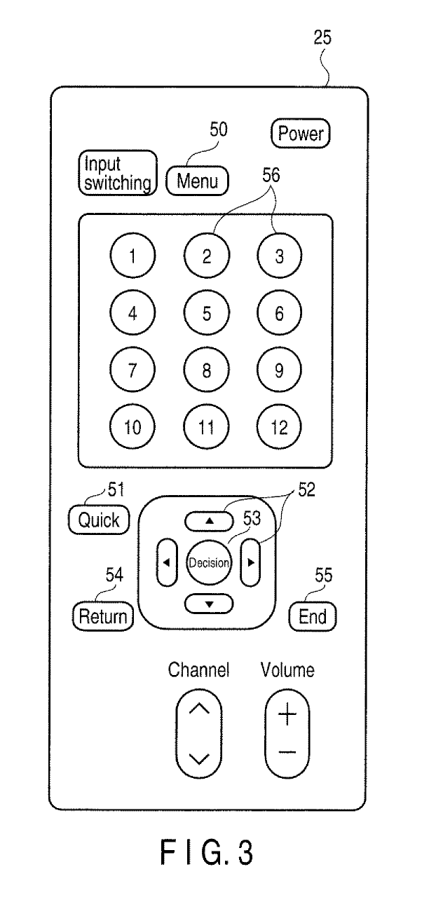

FIG. 3 shows various operating keys arranged on the remote controller 25. When the user operates a main MENU key 50 or a quick-menu key 51, a list of options available to the user is displayed on the display unit. Then, the user selects an option with direction keys 52 adapted to move a cursor, pointer, or the like left, right, up, or down. When the user operates a decision key 53, the option thus selected is decided. A RETURN key 54 is operated to recover the original screen. An END key 55 is operated to indicate the end of an operation.

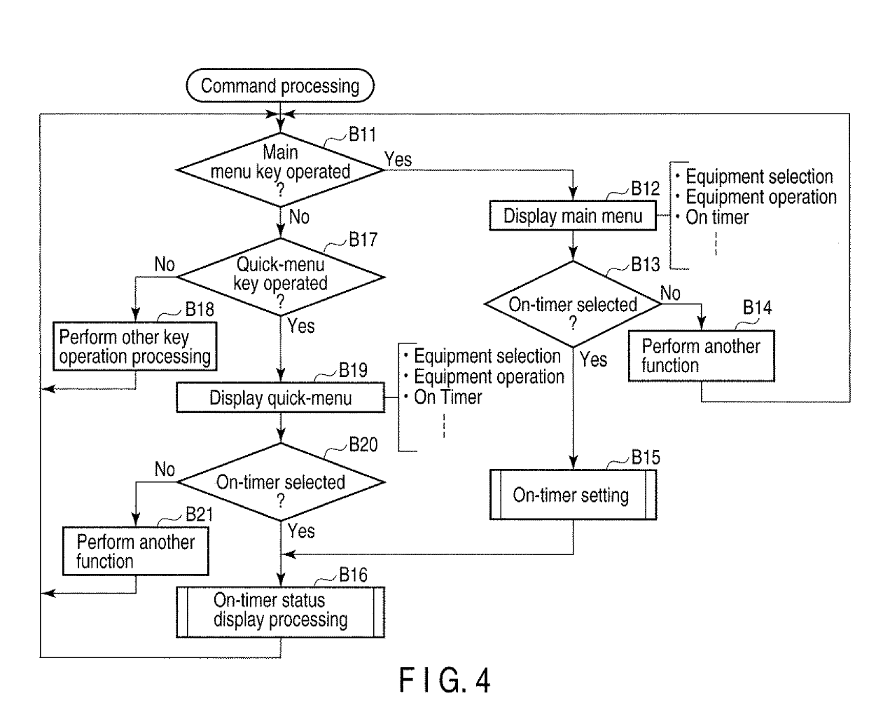

FIG. 4 shows command processing carried out by the microprocessor 10. The command processing is performed on commands input as operation information when the operator panel 23 or the remote controller 25 is operated. In the command processing, a check is first made in block B11 for the presence of an operation of the main MENU key 50. Upon detection of the operation of the main MENU key 50, the main menu is displayed in block B12. In the main menu, there are displayed options, such as “equipment selection”, “equipment operation”, “recording setting”, and “on-timer”. After display of the main menu, a check is made in block 813 as to whether the on-timer function has been selected from among the options. If the on-timer function has not been selected, then other processing is carried out in block 814 and a return is made to block B11.

If the “on-timer” function has been selected, the on-timer setting processing is carried out in block B15 and then the on-timer status display processing is carried out in block B16. After that, a return is made to block 811.

If no operation of the main MENU key is detected in block B11, a check is made in block B17 for the presence of an operation of the quick-menu key 51. If no operation of the quick-menu key 51 is detected, then other key operation processing is carried out in block B18 and a return is made to block B11. If the operation of the quick-menu key 51 is detected in block B17, the quick-menu is displayed in block B17. In the quick-menu, there are displayed options, such as “equipment selection”, “equipment operation”, and “on-timer”, etc. After display of the quick-menu, a check is made in block B20 as to whether the on-timer function has been selected. If the selection of the on-timer function is not detected, other processing is carried out in block B21 and a return is then made to block B11. If the selection of the on-timer function is detected in block 20, then the on-timer status display processing is carried out in block B16. After that, a return is made to block B11.

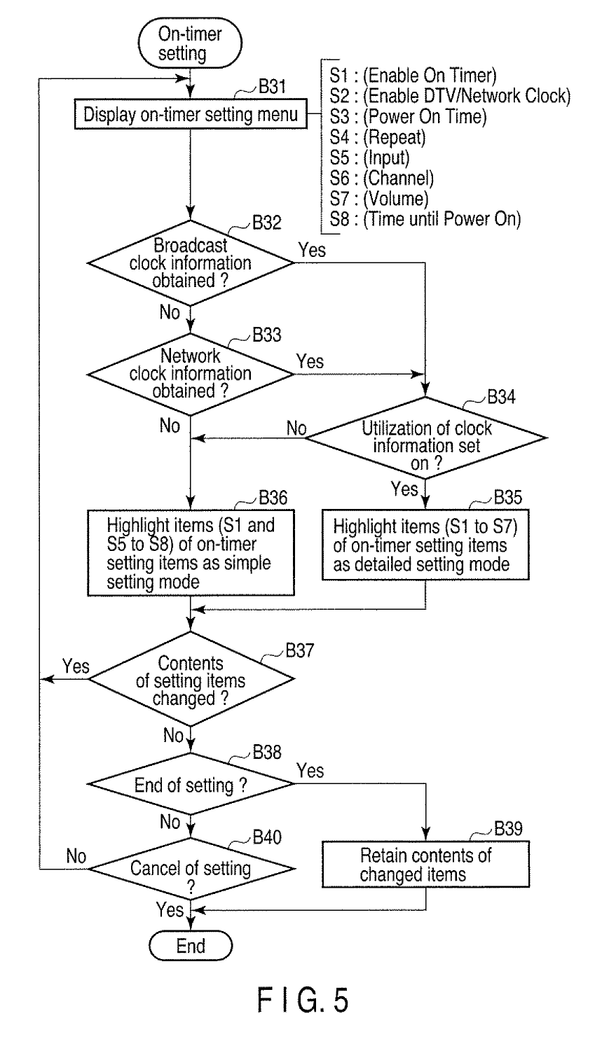

FIG. 5 shows the on-timer setting processing in block B15 of FIG. 4 in detail. In the on-timer setting processing, the microprocessor 10 first displays the on-timer setting menu on the display unit 20. The on-timer setting menu contains setting items S1 through S8 of on-timer utilization (Enable On Timer), clock information utilization (Enable DTV/Network Clock), power-on time, repeat range (Repeat), input signal source (Input), channel (Channel), volume (Volume), and time to until power on (Time until Power On). These items will be described later. In the initial state, items S1 through S8 are set to default contents in the flash memory 26.

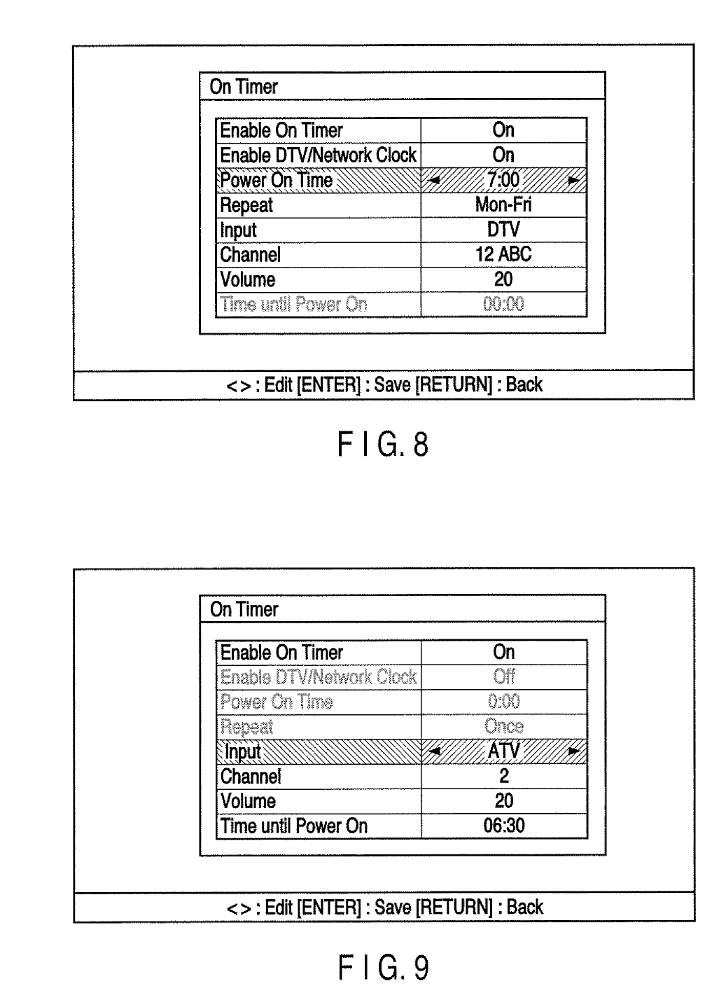

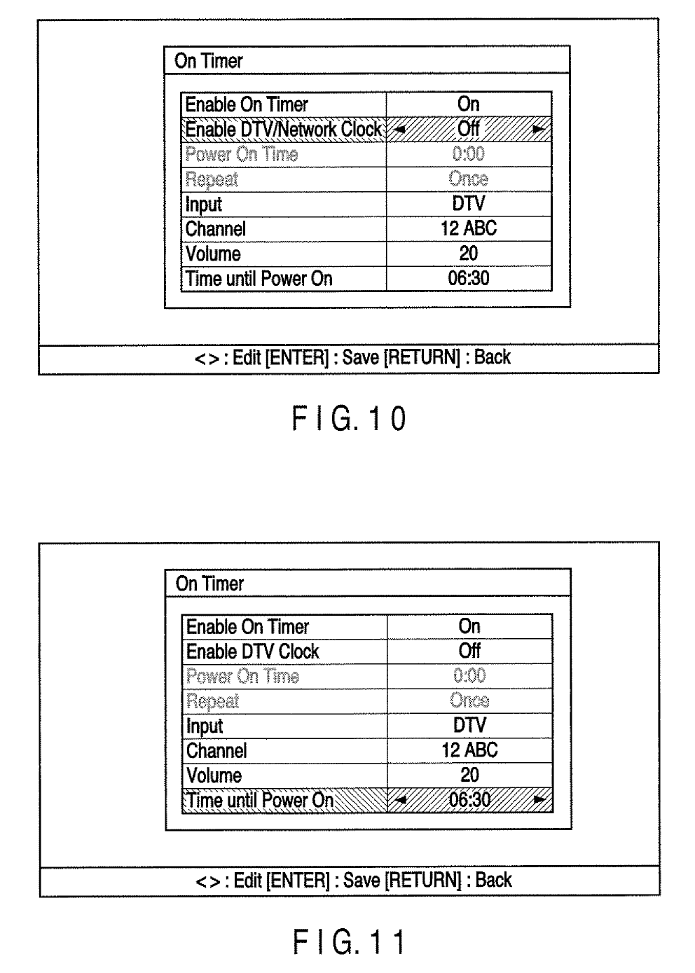

Subsequently, a check is made in block B32 as to whether the broadcast clock information has been obtained. A check is made in block B33 as to whether the network clock information has been obtained. If either the broadcast or network clock information has been obtained, then a check is made in block B34 as to whether utilization of the clock information has been set on by the default value or the user. If the utilization of clock information has been set on, items S1 through S7 of the on-timer setting items are highlighted in block B35 as a detailed setting mode, allowing the user to change settings. That is, the user is allowed to change settings (which will be described later with reference to FIG. 8). If, on the other hand, neither the broadcast nor network clock information is obtained and the clock information has been set off, the microprocessor 10 highlights items S1 and S5 to S8 of the on-timer setting items as a simple setting mode to allow the user to change settings (which will be described later with reference to FIGS. 9 and 10). Note here that setting item S2 associated with the utilization of clock information can be changed regardless of whether it is highlighted or not.

In changing the on-timer setting items, the user refers to the on-timer setting menu, then specifies setting items with the up and down direction keys 52 and changes the contents of the specified items using the left and right direction keys 52.

When it is detected in block B37 subsequent to block B35 or B36 that the contents of setting items have been changed, a return is made to block B31 to reflect the changed contents of setting items in the on-timer setting menu. If no change has been detected in block B37, a check is made in block B38 as to whether the end of setting has been indicated by operation of the decision (enter) key 53. If the end of setting is detected, the changed contents of the setting items are all retained in the flash memory 26 in block B39, thereby completing the on-timer setting processing. If, on the other hand, the end of setting is not detected in block B38, a check is made in block B40 for the cancellation of setting which is indicated by operation of the RETURN key 54. If the cancellation of setting is detected, the on-timer setting processing is terminated. If, on the other hand, the cancellation of setting is not detected in block B40, a return is made to block 31 to continue to change the contents of the setting items.

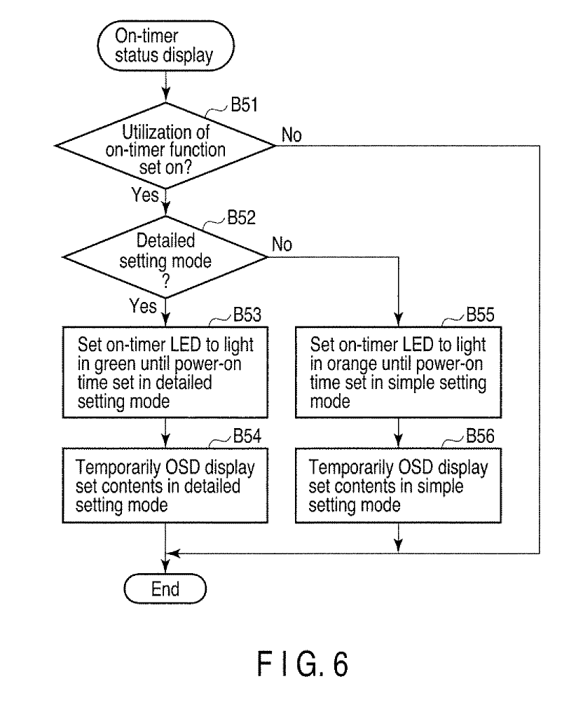

FIG. 6 shows the on-timer status display processing in block B16 of FIG. 4 in detail. In the on-timer status display processing, the microprocessor 10 first judges in block B51 whether the utilization of the on-timer function has been enabled (set) from, for example, the contents retained in the flash memory 26. If the utilization of the on-timer is not enabled, the on-timer status display processing is terminated.

If it is detected in block B51 that the utilization of the on-timer function has been enabled, a check is made in block B62 as to whether the utilization of the on-timer function has been enabled in the detailed setting mode. If the on-timer has been enabled in the detailed setting mode, then the on-timer LED 20A is set in block B53 to light in green until the set power-on time (see FIG. 2). In subsequent block B54, the set contents in the detailed setting mode are temporarily OSD displayed (which will be described later with reference to FIG. 12). In this case, the on-timer LED 20A and the OSD display function as an indication module.

If, on the other hand, it is not detected in block B52 that the on-timer has been enabled in the detailed setting mode, then the on-timer LED 20A is set in block B55 to light in orange for the time until power on set in the simple setting mode (see FIG. 2). In subsequent block B56, the set contents in the simple setting mode are temporarily OSD displayed. In this case as well, the on-timer LED 20A and the OSD display function as the indication module.

The on-timer status display process is terminated with the completion of execution of the processing in block B54 or B56.

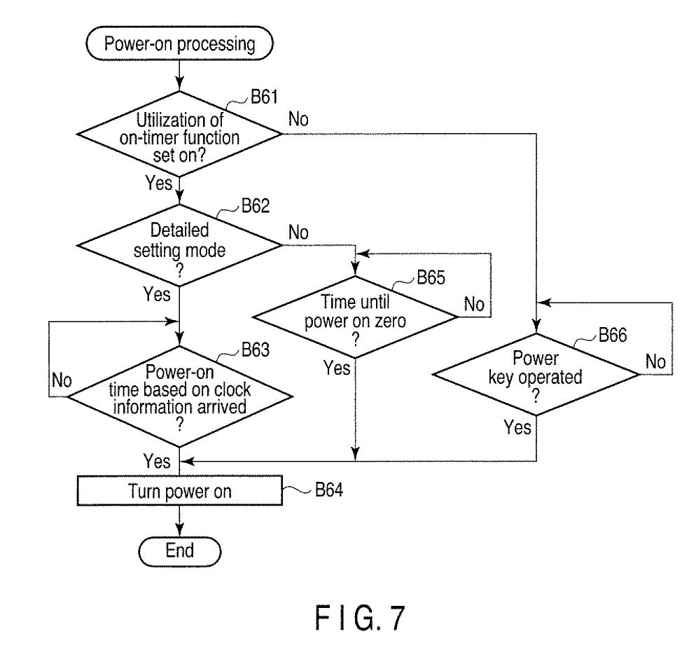

FIG. 7 shows the power-on processing carried out by the microprocessor 10 shown in FIG. 1 as a standby power operation. The power-on processing is carried out in the state where the power has been turned off by operating the remote controller 25 or the operator panel 23. In block B61, a check is made as to whether the utilization of the on-timer has been enabled. If the utilization of the on-timer has been enabled, a check is made as to whether the setting is in the detailed setting mode in block B62. Upon detection of the setting in the detailed setting mode, a check is made repeatedly in block B63 as to whether the current time based on the broadcast or network clock information has arrived the power-on time. Upon detecting the arrival of the power-on time, the power is turned on in block B64, thereby terminating the power-on processing.

If it is not detected in block B62 that the utilization of the on-timer function has been enabled in the detailed setting mode, then a check is made repeatedly in block B65 as to whether the time until power on is 0. If the time until power on is 0, the power is turned on in block B64, thereby terminating the power-on processing.

Further, if the utilization of the on-timer function has not been enabled in block B61, a check is made in repeatedly in block B66 for the presence of an operation of the power key. Upon detection of the operation of the power key, the power is turned on in block B64, terminating the power-on processing.

Next, there is illustrated in FIG. 8 an example of setting the power-on time on the on-timer setting menus when the broadcast or network clock information is employed (detailed setting mode). Here, the power-on time is set to “7:00” by operating the left and right direction keys 52. In the detailed setting mode, year, month, day, hours and minutes can be selected as the power-on time. Every day, weekday, weekend and every week can be selected as the repeat range of the power-on setting. For the input signal source, the channel, and the volume, items of default information such as of “digital broadcasting (DTV), “12 ABC”, and “20” are prepared, respectively, in common to the detailed setting mode and the simple setting mode.

There is illustrated in FIG. 9 an example of setting an input signal source at the power-on time when the utilization of the broadcast and network clock information is set off on the on-timer setting menu (simple setting mode). Here, the input signal source is set to “analog broadcasting (ATV)” by operating the left and right direction keys 52. The item or items faintly displayed in each setting mode are unnecessary or invalid.

There is illustrated in FIG. 10 an example in which the clock information is not utilized in block B36 of FIG. 5 although it can be obtained. Here, the utilization of DTV/network clock information is set “off” by operating the left and right direction keys 52. In FIG. 11 there is illustrated an example in which the time until power on is set as a subsequent setting operation to the settings shown in FIG. 10. Here, the time until power on is set to “6:30 (6 hours and 30 minutes)” by operating the left and right direction keys 52.

In FIG. 12 there is illustrated an example of on-timer status OSD display as the result of processing in block B54 shown in FIG. 6. In this display example, it is indicated that the power-on time is “7:00” and the time until power on is “5 hours and 30 minutes”.

In the broadcast receiving system of this embodiment, even if the broadcast or network clock information can be obtained, it is allowed to set the time until power on in place of the power-on time in the on-timer setting menu. For example, in regions where the clock information is low in reliability, it becomes possible to set the time until power on in the on-timer setting menu by the user operating the operator panel 23 or the remote controller 25 in order to avoid correction of the internal clock by wrong clock information. Accordingly, it becomes possible to put the on-timer function to practical use.

The invention is mot limited to the embodiment described above, but can be modified in various forms.

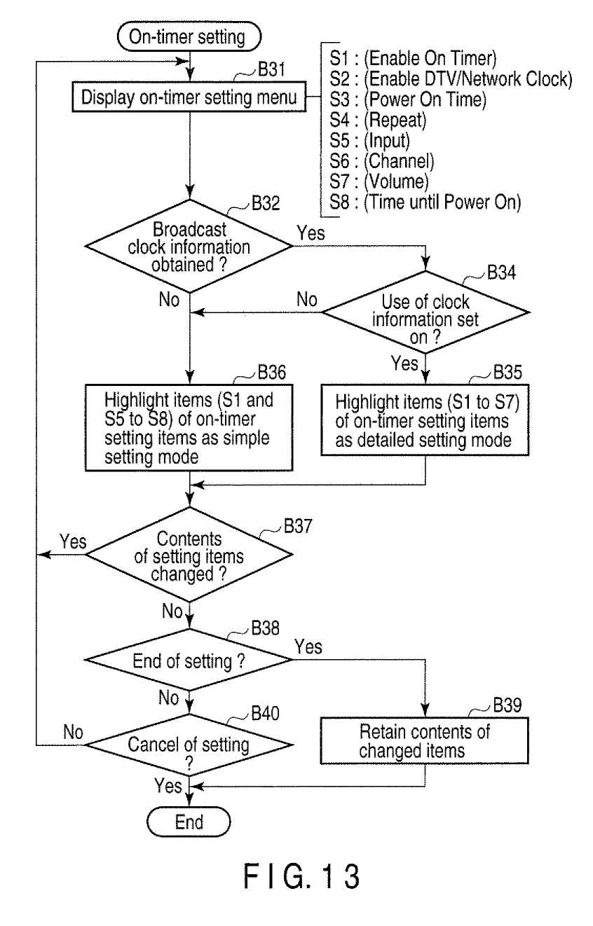

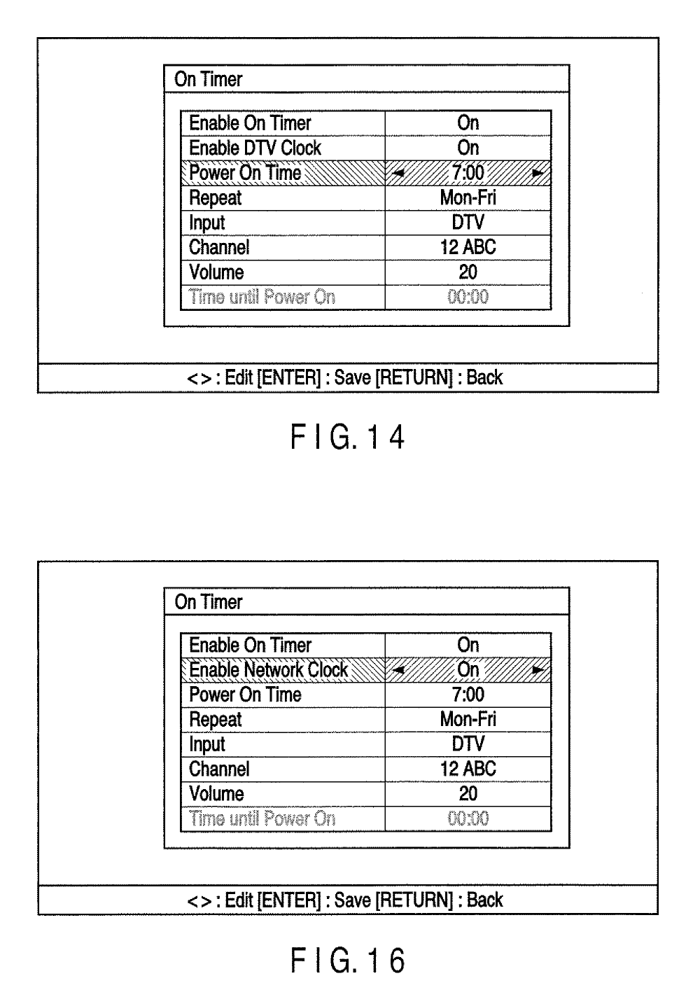

For example, the on-timer setting processing shown in FIG. 5 may be modified like a first modification shown in FIG. 13. In this modification, block 33 of FIG. 5 is deleted which is associated with obtaining of the network clock information. In this case, the on-timer setting menu is changed as shown in FIG. 14 by way of example. That is, in FIG. 14, the item associated with utilization of the network clock information, “Enable Network Clock”, is deleted.

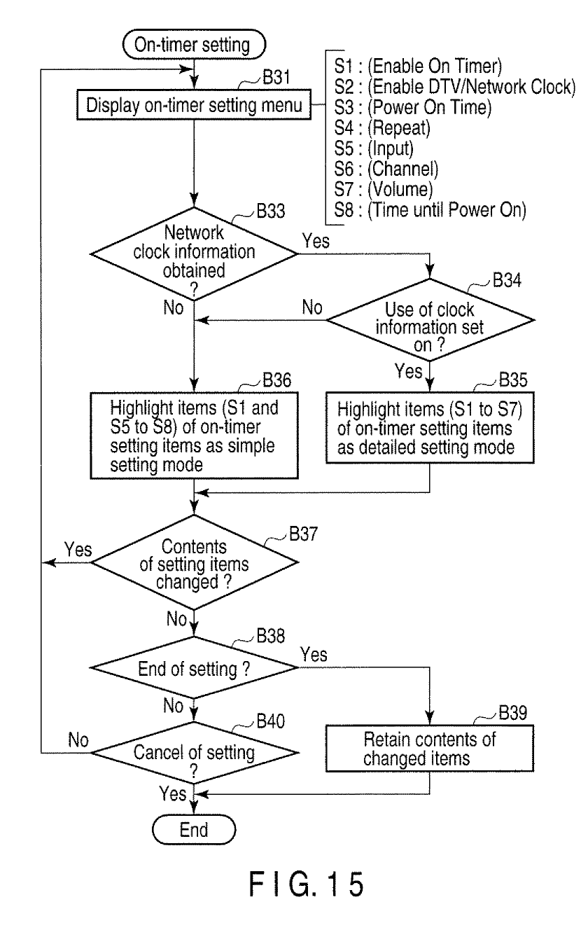

In addition, the on-timer setting processing shown in FIG. 5 may be modified like a second modification shown in FIG. 15. In this modification, block 32 of FIG. 5 is deleted which is associated with obtaining of the broadcast clock information. In this case, the on-timer setting menu is changed as shown in FIG. 16 by way of example. That is, in FIG. 16, the item associated with the broadcast clock information, “Enable DTV Clock”, is deleted.

Note that the setting items of the on-timer setting menu may be changed arbitrarily.

In addition, the form of OSD display in the on-timer status display processing may be changed arbitrarily.

Furthermore, the power-on time and the time until power on may be input by operating channel keys 56 in place of numeric keys.

Moreover, various modules of the system described herein can be implemented with software applications, hardware and/or software modules, or components on one or more computers such as servers. These modules may be allocated to all or part of basic logic or codes while they are described separately.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiving system comprising:
a receiving module configured to receive a broadcast signal;
a display processing module configured to display an on-timer setting menu associated with at least the power-on of the receiving module;
an operation module configured to perform input operations for setting items of the on-timer setting menu; and
a control module configured to refer to an internal clock which is corrected with reference to clock information received from the outside and perform power control in accordance with the contents set by the input operations of the operation module on the on-timer setting menu,
the control module being configured to allow selection of either of utilization and non-utilization of the clock information in the on-timer setting menu, to correct the internal clock using the clock information and allow the power-on time to be set in a detailed setting mode if the clock information is received from the outside and the utilization of the clock information has been selected, and to allow the time until power on to be set in a simple setting mode without correcting the internal clock if the non-utilization of the clock information has been selected.

2. The broadcast receiving system of claim 1, wherein the control module is configured to set the range to repeat power-on operations as a setting item in the detailed setting mode.

3. The broadcast receiving system of claim 1, wherein the control module is configured to set the input signal source, the channel, and the volume as common setting items in the detailed and simple setting modes.

4. The broadcast receiving system of claim 1, wherein the control module includes an indication module which indicates which of the detailed and simple setting modes the on-timer setting mode is.

5. The broadcast receiving system of claim 4, wherein the indication module includes an LED which is adapted to change its display color between the detailed and simple setting modes.

6. The broadcast receiving system of claim 1, wherein the control module is configured so as not to allow the power-on time to be set in the on-timer setting menu in the event that the clock information cannot be obtained from a broadcast signal.

7. The broadcast receiving system of claim 1, wherein the control module is configured so as not to allow the power-on time to be set in the on-timer setting menu in the event that the clock information cannot be obtained from a network.

8. The broadcast receiving system of claim 1, wherein the control module is configured so as not to allow the power-on time to be set in the on-timer setting menu in the event that the clock information cannot be obtained from a broadcast signal and a network.

9. A control method for use with a broadcast receiving system comprising: a receiving module configured to receive a broadcast signal; a display processing module configured to display an on-timer setting menu associated with at least the power-on of the receiving module; an operation module configured to perform input operations for setting items of the on-timer setting menu; and a control module configured to refer to an internal clock which is corrected with reference to clock information obtained from the outside and perform power control in accordance with the contents set by the input operations of the operation module on the on-timer setting menu, the control method comprising:
allowing a selection of either of utilization and non-utilization of the clock information in the on-timer setting menu;
correcting the internal clock using the clock information and allowing the power-on time to be set as a detailed setting mode if the clock information is obtained from the outside and the utilization of the clock information has been selected in the on-timer setting menu, and
allowing the time until power on to be set as a simple setting mode without correcting the internal clock if the non-utilization of the clock information has been selected.
